(19) United States
(12) Patent Application Publication
(10) Pub. No.: US 2007/0009396 A1
(43) Pub. Date: Jan. 11, 2007

(54) Multi-well plate guide protector and method for multi-well dispensing

(75) Inventor: Stephen Ho, Hong Kong (HK)

Correspondence Address: EAGLE IP LIMITED, UNIT 1201, 12/F KWAI HUNG HOLDINGS CENTRE, 89 KING'S ROAD, NORTH POINT, HONG KONG, CN

(73) Assignee: Hong Kong CH Gene Ltd

(21) Appl. No.: 11/175,088

(22) Filed: Jul. 5, 2005

(51) Int. Cl. B01L 9/00

(52) U.S. Cl. 422/104

(57) ABSTRACT

The invention discloses a multi-well plate guide protector for single- and multi-well dispensing in a multi-well plate. The guide protector comprises a protecting cover having a height and dimension adapted for protecting the multi-well plate. The protecting cover has a dispensing window through the protecting cover adapted for allowing accurate and easy dispensing fluid in the well, row or column, of interest in the multi-well plate therethrough. The guide protector further comprises a position coupling coupled to the protecting cover. The position coupling is configured to move along on a position track on the multi-well plate for guiding the movement of the protecting cover so that the dispensing window can align with a targeted well in the multi-well plate.

### FIELD OF INVENTION

This invention relates generally to laboratory equipment for guiding multi-well dispensing. More particularly, the invention relates to a multi-well plate guide protector and will be described hereinafter with reference to this application.

### BACKGROUND OF INVENTION

Multi-well plates are common laboratory products used in high throughput manual sample preparation. Among the problems involved during manual sample preparation using multi-well plates are fatigue, difficulty identifying a single well and other errors. To minimize these problems, various equipments have been devised and made available in the market. For example, 96-well plate row indexers and 96-well column indexers are available in the market to allow additions by row or column to a 96-well plate by stepwise movement of a base beneath the 96-well plate (see, http://www.horizon-specialty.com/products1.htm). Another example is so-called “Multi Well Plate Well Guide” available from Pioneer Scientific Co. which appears to be a sliding guide, above a microplate, to help align a pipetter with the microplate wells (see, http://ibdev.com/Merchant2/merchant.mv?Screen=CTGY&Store_Code=PS01&Category_Co de=Well+Guide).

It is an object of the present invention to overcome or ameliorate one or more of the deficiencies of the prior art, or at least to provide a useful alternative.

### SUMMARY OF INVENTION

Accordingly, in a first aspect, the invention provides a multi-well plate guide protector for multi-well dispensing in a multi-well plate comprising axially extending columns and transversely extending rows of wells, the guide protector comprising: a shielding portion for covering at least some of said columns and rows; a dispensing window for selectively exposing a targeted one of said columns or rows to allow for dispensing into the targeted column or row, and said guide protector being at least transversely or axially movable relative to the multi-well plate to selectively align said window with said targeted column or row. In the preferred embodiment, a positioning mechanism is provided for guiding the movement of the guide protector relative to the plate such that the protector can move in a series of incremental positions, each position aligning said dispensing window to a column or row of the plate.

In a second aspect, the invention provides a multi-well plate guide protector set for multi-well dispensing in a multi-well plate comprising axially extending columns and transversely extending rows of wells, the guide protector set comprising:

a base for mounting a multi-well plate;

a guide protector at least axially or transversely slidably mounted to the base, said guide protector including:

a shielding portion for covering at least some of said columns and rows;

a dispensing window for selectively exposing a targeted one of said columns or rows by transversely or axially sliding the guide protector relative to the base until the window aligns with the targeted column or row to allow for dispensing into the targeted column or row.

In a third aspect, the invention provides a method of performing single-row, single-column, or single-well dispensing in a multi-well plate, the method comprising the steps of:

(i) providing a multi-well plate guide protector as defined above;

(ii) moving said guide protector relative to the multi-well plate to align said dispensing window with a target row or column of said multi-well plate;

(iii) dispensing fluid into said target row or column.

Preferably, steps (ii) and (iii) are repeated until a required number of said wells are filled.

In a fourth aspect, the invention provides a method of transferring fluid between a source multi-well plate and a daughter multi-well plate, the method comprising the steps of:

a. providing a multi-well plate guide protector set as defined above, said guide protector set having a said guide protector for said source multi-well plate and a said guide protector for said daughter multi-well plate;

b. moving the guide protector for the source plate to align its dispensing window with a target row or column in said source plate and moving the guide protector for the daughter plate to align its dispensing window with a target row or column in said daughter plate;

c. transferring fluid from a target well in the source plate to a target well in the daughter plate.

Preferably, steps (b) and (c) are repeated until a required number of wells in said daughter plate are filled.

In a preferred application, the method is used for transferring fluid between a source plate and a daughter plate such as Enzyme Link Immunosorbent Assay (ELISA) or Polymerase Chain Reaction (PCR) experiments.

### BRIEF DESCRIPTION OF THE DRAWINGS

Preferred embodiments of the invention will now be described, by way of example only, with reference to the accompanying drawings, in which:

FIG. 1 shows a preferred embodiment of a multi-well column guide protector according to the present invention for use in multi-well dispensing;

FIG. 2 shows preferred embodiments of multi-well column and row guide protectors according to the present invention for use in multi-well dispensing;

FIG. 3 shows another embodiment of a multi well guide protector according to the present invention for use in multi-well dispensing, wherein the guide protector is provided with a slidable door for incremental opening of the dispensing window;

FIG. 4 shows a single plate embodiment of a multi-well guide protector set according to the present invention for use in multi-well dispensing;

FIG. 5 shows a double plate embodiment of a multi-well guide protector set according to the present invention for use in transferring fluid between source and daughter well plates;

FIG. 6 shows the column guide protector set of FIG. 4 in use;

FIG. 7 shows the row guide protector of FIG. 4 in use;

FIG. 8 shows the row guide protector set of FIG. 5 in use for transferring fluid between rows of wells of source and daughter plates; and

FIG. 9 shows the column guide protector set of FIG. 5 in use for transferring fluid between columns of wells of source and daughter plates.

### DETAILED DESCRIPTION

The accompanying figures and this description depict and describe the preferred embodiments of a multi-well plate guide protector in accordance with the present invention, and features and components thereof. The present invention also encompasses a method of making and using embodiments of the multi-well plate guide protector.

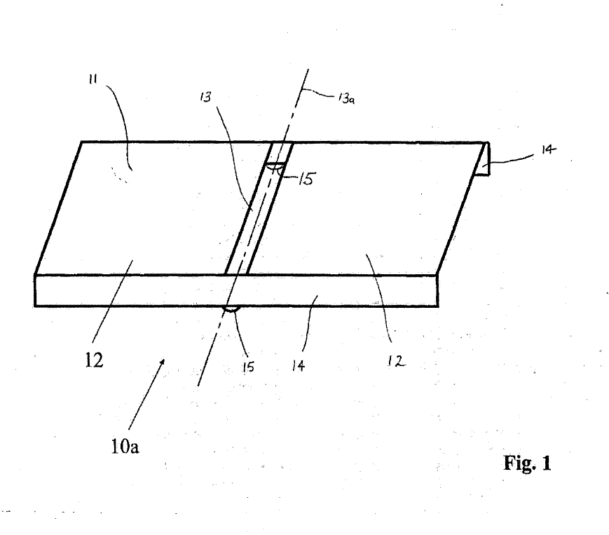

FIG. 1 shows a multi-well plate column guide protector 10a comprising a generally solid body 11 including generally planar shielding portions 12 and a dispensing window 13 between the shielding portions 12. The window has an axis 13a. The guide protector has sidewalls 14 that extend perpendicularly from the shielding portions 12 and perpendicularly to the axis 13a of the window 13, such that the guide protector has a generally C-shaped transverse cross-section. A positioning lug 15 extends from each of the sidewalls. The dispensing window 13 allows pipetting or dispensing of fluid therethrough. In other embodiments (not shown) the positioning lug 15 can be attached to another part of the guide protector as long as it facilitates the moving or traveling of the guide protector.

The size (the height and dimension) of the guide protector 10a is chosen so as to be suitable for protection of multi-well plates while performing pipetting or dispensing. The guide protector typically has a height fit for 96 wells or PCR plates. In some embodiments, the length, width, and height of the guide protector 10a is slightly greater than the size of the multi-well plate intended for pipetting or dispensing, usually in the range around 100-300 mm in length; 80-200 mm in width; and 10-100 mm in height. The guide protector is preferably configured to utilize friction to make the guide protector more easily controllable and help position the dispensing window 13 toward the targeted well, row, or column. Whatever size of guide protector is selected, the shielding positions 12 should preferably substantially protect or cover the wells of the plate in which dispensing is not being performed.

In another embodiment, the guide protector 10a has indicia, in the form of alphabetical or numerical markings, alongside the dispensing window 13. The markings are used to aid location of a targeted well, or row, or column in the multi-well plate covered by guide protector.

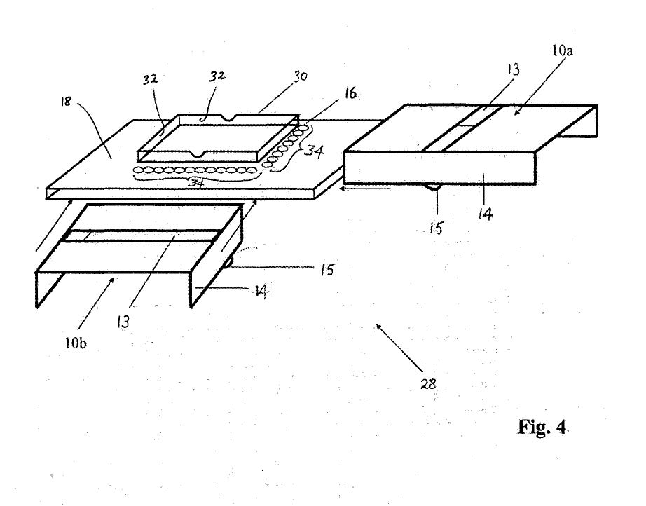

In the embodiment shown, the positioning lugs 15 protrude from the sidewalls 14 of the guide protector. The lugs 15 engage corresponding alignment recesses 16 on a base 18 (to be shown in FIG. 4) for aiding accurate alignment of the window 13 with a targeted well in the multi-well plate. This is one preferred embodiment of the positioning mechanism.

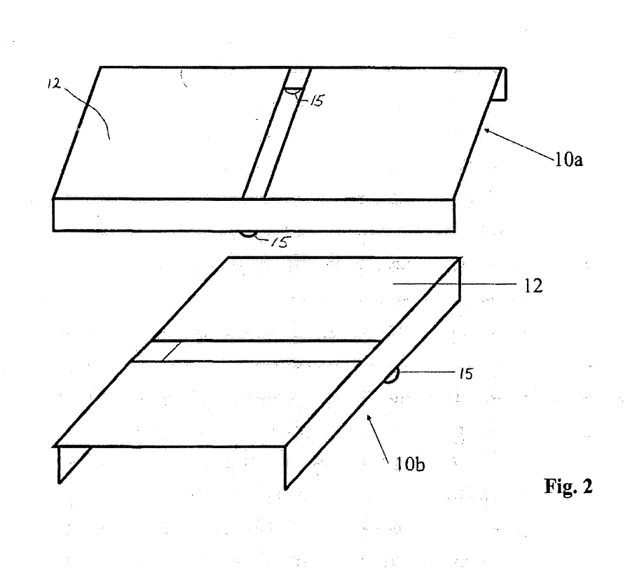

FIG. 2 shows a column guide protector 10a and a row guide protector 10b respectively. The former is suitable for allowing multi-well dispensing column-wise while the later is suitable for row-rise dispensing. Except for the dimensions of the window and the solid body, their features are the same those shown in FIG. 1 and therefore not repeated here.

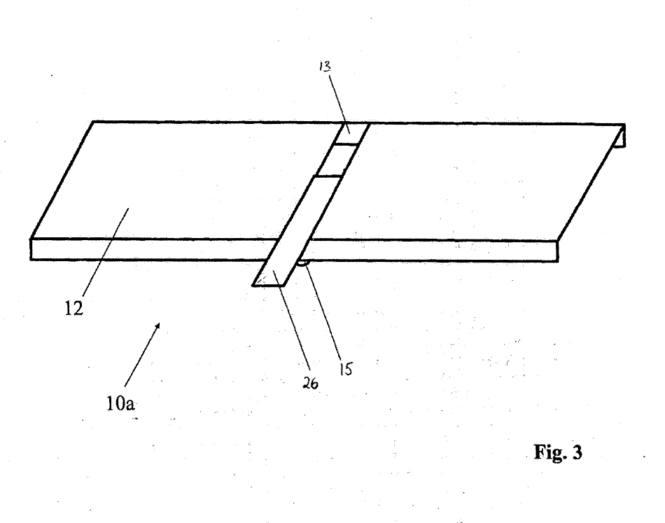

FIG. 3 shows another embodiment of the multi-well plate guide protector 10a of the present invention, wherein the guide protector further comprises a door 26. The door 26 is slidable relative to the guide protector 10a within a track (not shown) for incrementally opening or uncovering the dispensing window 13 in increments of one well for single well dispensing. The other features remain the same as those shown in FIGS. 1 and 2 and given the same reference numerals.

FIG. 4 shows a single plate embodiment of a multi-well guide protector set 28. The guide protector set 28 comprises a column guide protector 10a, a row guide protector 10b and a base 18 complementary with the guide protectors 10a and 10b. The base 18 includes a multi-well plate holder 30 comprising retaining walls 32 extending perpendicularly from the base to define a rectangular retaining space for holding a multi-well plate 22 (not shown in FIG. 4). The sidewalls 14 of the guide protectors 10a and 10b are adapted to engage the retaining walls 32 of the holder 30 to guide the guide protectors during sliding movement relative to the base 18.

In the specific embodiment shown in FIG. 4, the base 18 further comprises position track 34 including a sufficient number of alignment recesses 16, for example eight or twelve recesses, or multiples of eight or multiples of twelve recesses, for aiding alignment of the dispensing window 13 to a targeted row or column of wells. In particular, the positioning lug 15 and the position track 34 form a position guide with incremental coupling mechanisms to guide the movement of the guide protector 10a or 10b such that the dispensing window 13 can be accurately aligned with a targeted well in the plate. In the preferred embodiment, the position track 34 is provided with a plurality of alignment recesses 16 each corresponding to a particular column or row of wells, such that the position lug 15 is adapted to interact with a selected recess 16 in the position track 34. When the user wants to move the dispensing window 13 to expose another well, he can move the guide protector until the positioning lug 15 mates with the alignment recess 16 corresponding to the desired well.

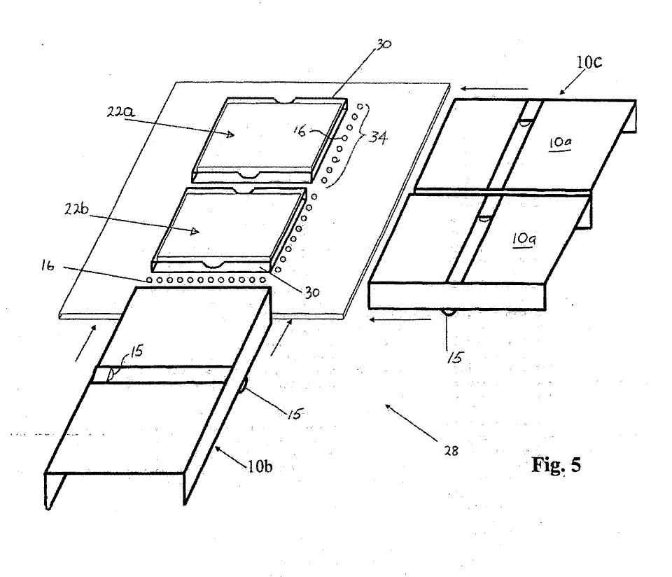

FIG. 5 illustrates a double plate embodiment of the multi-well guide protector set 28. The guide protector set 28 comprises at least one row guide protector 10b or one double column guide protector 10c and a base 18. In this example, guide protector 10c is made by joining two single column guide protectors by a coupling lock. The base 18 herein has space for two multi-well plates 22a and 22b placed side-by-side in the respective plate holders. As shown in the figure, the position track 34 is configured to guide the movement of the guide protector as described above.

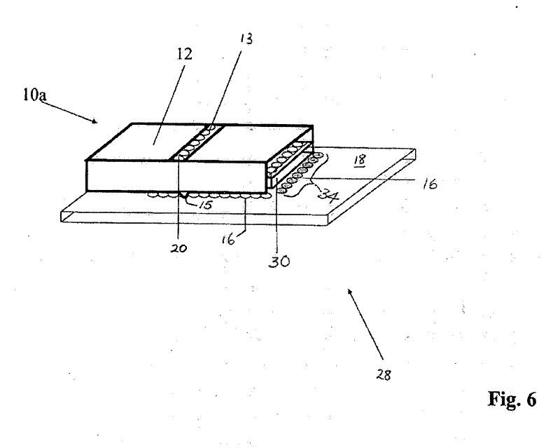

FIG. 6 shows one embodiment of the method of using the multi-well guide protector set 28 for single plate vertical pipetting, that is, column-by-column dispensing. The guide protector set 28 includes a guide protector 10a that has a dispensing window 13 for allowing pipetting vertically or column by column, a plate holder 30, and position tracks 34 along one or more sides of the perimeter of the plate holder 30. In practice, a multi-well plate is placed in the holder 30 in the base 18 of the guide protector set 28. The multi-well plate typically contains a plurality of rows and columns of wells. In this embodiment, each alignment recess 16 in position track 34 aligns with a row or column of wells 20 in the multi-well plate. The guide protector 10a is then slidably connected to the base 18 such that all the wells in the multi-well plate except those exposed by dispensing window 13 are covered by the shielding portions 12. The guide protector 10a is then slidably moved to align the dispensing window 13 with wells 20 in a first target column. An operator can then dispense fluid in the wells 20 through the dispensing window 13. After dispensing is complete in all the wells in the first target column, the operator can slide the guide protector 10a relative to the base 18 to align the dispensing window 13 with the next target column of wells and perform dispensing therein. This step can be repeated again and again until all the wells 20 in all the columns of interest are completed with dispensing. As shown in the figure, the positioning lugs 15 and alignment recesses 16 guide the movement of the guide protector 10a during movement relative to the base 18.

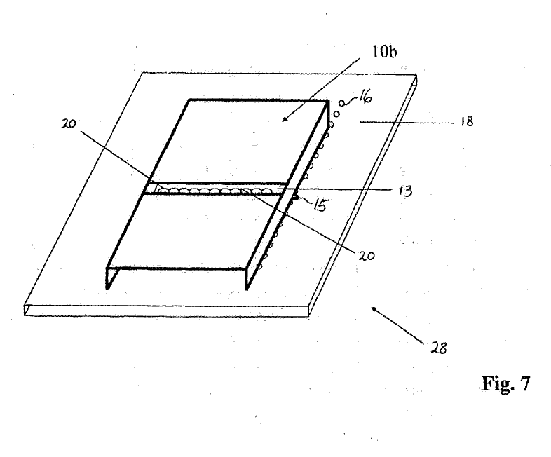

FIG. 7 shows another embodiment of the method of using the multi-well guide protector set 28 for single plate row-wise or horizontal pipetting; that is, row-by-row dispensing. This guide protector set 28 includes a guide protector 10b that has a dispensing window 13 for allowing pipetting horizontally or row by row. In practice, the guide protector 10b is slidably connected to the base 18 such that the shielding portions 12 protect wells in the multi-well plate except those exposed by the dispensing window 13. The guide protector 10b is then slidably moved to align the dispensing window 13 with wells 20 in the first target row. An operator can then dispense fluid in the wells 20 through the dispensing window 13. After all the wells in the first target row are finished with dispensing, the operator can slide the guide protector relative to the base 18 to align the dispensing window 13 with next target row of wells and perform dispensing therein. This step can be repeated until all the wells 20 in all the rows of interest are completed with dispensing. As shown in the figure, positioning lugs 15 and alignment recesses 16 guide the movement of the guide protector 10b during movement relative to the base 18.

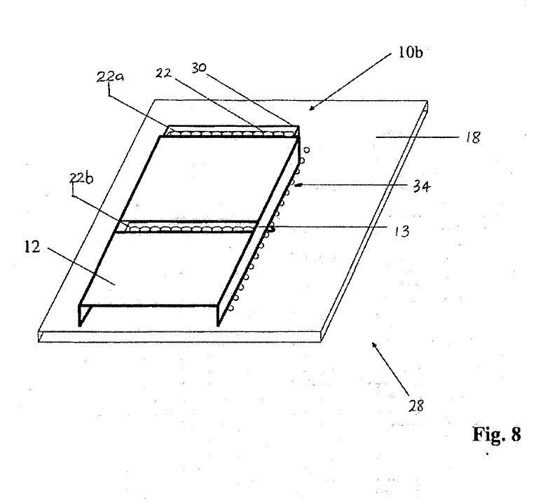

FIG. 8 shows an embodiment of the method of using the multi-well guide protector set 28 for double plate horizontal or row-wise pipetting. The guide protector set 28 has a base 18 with two multi-well plates 22a and 22b arranged as shown in FIG. 6 and a guide protector 10b with a dispensing window 13 that allows horizontal pipetting. The guide protector 10b is first slidably moved to align the top margin of protector 10b to expose a target source row of wells 20 in plate 22a that acts as a source plate in this example. At the same time, the dispensing window 13 exposes a corresponding row of wells in plate 22b that will act as the daughter wells for receiving material delivered from the source row of wells. Clearly, it is most preferable that the area of the solid body of the guide protector is designed such that it corresponds to the size of the multi-well plate it is designed to protect (and taking into consideration the design of the base), such that exposure of one row in the first plate through the dispensing window results in exposure of a corresponding row in the other plate along the edge or top margin of the protector. A pipette is used to remove a portion of fluid from a designated source well in the target source row. The fluid in the pipette is then deposited into the daughter wells of the target daughter row to complete the fluid transfer. The guide protector 10b can then be slidably moved to align the top margin of protector 10b to expose the next target source row of wells 20 in plate 22a. In so doing, the dispensing window 13 will correspondingly be moved to expose the next row of wells of the daughter plate 22b. The user can repeat the procedure to transfer fluid from the source row to the daughter row as mentioned above. As shown in the figure, positioning lugs 15 and alignment recesses 16 guide the movement of the guide protector 10b during movement relative to the base 18.

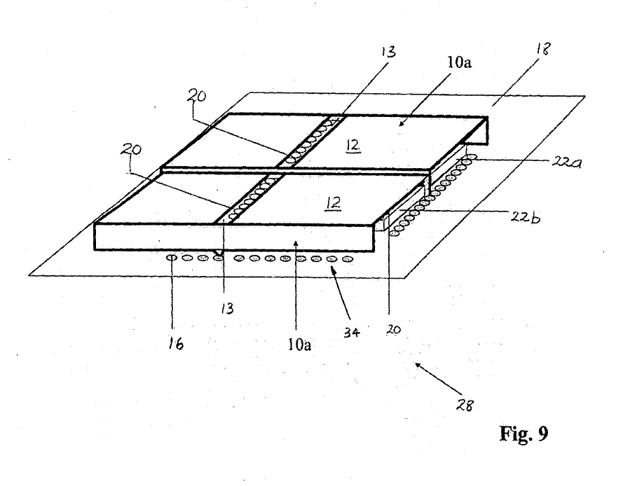

FIG. 9 shows a method of using the multi-well guide protector set 28 for double plate vertical or column-wise pipetting or dispensing. The guide protector set 28 has a base 18 with plate holders that holds two multi-well plates 22a and 22b and guide protectors 10c. In this mode of operation, the guide protector 10c is made of two single column guide protectors 10a fixedly joined together by a coupling lock such that their respective windows are fall on the same axis. Each of the dispensing window 13 allows vertical, or column-wise pipetting. In preparation for fluid transfer between two plates, one of the multi-well plates 22, acting as a source multi-well plate, and the other plate 22 acting as a daughter multi-well plate, are placed within the respective plate holders 30 (not shown in FIG. 9 for ease of illustration—refer to FIG. 5 to view the plate holders 30) of the base 18. The shielding portions 12 of guide protector 10c covers all the wells of multi-well plates 22a and 22b except those exposed by dispensing windows 13. Transfer of fluid from the source plates to the daughter plate is then performed on respective wells in the plates. After all of the wells in the first target column are finished with the fluid transfer, the guide protector 10c of the source and daughter plates can be moved to align the dispensing window with the next target column of wells to continue fluid transfer as described above. As the windows of protector 10c are axially aligned, there is no chance that an operator could dispense into the wrong column.

Finally, the same principle of use may be applied to the embodiment shown in FIG. 3 in which a movable door is provided. Since the way of operation is essentially the same as in the previous description and figures, no additional figures are provided to illustrate the operation of this embodiment. Briefly, the door 26 may be opened to any extent as determined by the user to uncover, for example, a single target well below the dispensing window 13 to allow dispensing in the well. Thereafter, the door can be opened further to uncover the next target well in the target row or column for performing dispensing therein until all the wells in the target row or column are filled. The door can then be closed and the protector shifted such that the window is directly above the next row of target cells. The door can then be opened one well at a time for dispensing in the next target row. Clearly, this embodiment is particularly useful for dispensing wells one by one rather than a whole row or column simultaneously.

Therefore, a multi-well plate guide protector and a method of making and using the multi-well plate guide protector are described here. The present invention has advantages such as allowing accurate and easy dispensing of fluid in a target well, row or column, in a multi-well plate; protecting untargeted wells from contamination, for example caused by accidental dropping of loosen pipette, spilling while loading samples, unintended physical contact or touching of the wells/samples by operators; and minimizing overall evaporation and air contamination.

While the present invention has been described with specific references to the aforesaid figures, it should be understood that the figures are for illustration only, and that many other variations, combinations and embodiments may be designed by one skilled in the art based on the teaching provided herein. It is therefore intended that the invention be interpreted based on the scope of the claims. For example, the lugs and alignment recesses are for illustration only, and any suitable guiding and positioning mechanism or method may be used to guide and move the protector so that the dispensing window may be accurately, conveniently and precisely moved to a position to expose a targeted, well, row, or column. For example, the lugs may be in the form of a circular body, such as a ball, or a metal ring, or a male tracking. The length and width of the dispensing window preferably corresponds to a row or a column for vertical or horizontal dispensing. However, other sizes, such as but not limited to sizes for simultaneous double row or column dispensing is also envisioned. The shape and height of the protector as described is for illustration only and other shapes and sizes may be determined by one skilled in the art and are within the scope of the claims.

With regard to fastening, coupling, mounting, attaching or connecting components of the present invention to form the multi-well plate guide protector as a whole, unless specifically indicated to the contrary herein, such are intended to encompass conventional fasteners such as threaded or bayonet connectors, snap rings, detent arrangements, clamps, rivets, toggles, pins and the like, including indirect coupling or connections. Components may also be connected by adhesives, glues, welding, ultrasonic welding, or friction fitting or deformation, if appropriate, and appropriate liquid and/or airtight seals or sealing devices may be used. Unless specifically otherwise disclosed or taught herein, materials for making components of the present invention may be selected from appropriate materials such as acrylic, metal, metallic alloys, natural and manmade fibers, paper, cardboard paper, vinyl, plastics, other autoclavable and cleanable materials, and the like, and appropriate manufacturing or production methods including casting, pressing, extruding, molding and machining may be used.

Any references to front and back, right and left, top and bottom and upper and lower are intended for convenience of description, and not to limit the present invention or its components to any one positional or spatial orientation.

The methods and multi-well plate guide protectors of the present invention will be useful for protecting and aiding positioning of a multi-well plate for multi-well dispensing or pipetting. As used herein, “multi-well dispensing or pipetting” is intended to have its common, technical meaning. While the present invention is useful in 96 multi-well plates, it will also find use with other multi-well plates, such as 12 multi-well, 24 multi-well or 384 multi-well plates.

I claim:

1. A multi-well plate guide protector for multi-well dispensing in a multi-well plate comprising axially extending columns and transversely extending rows of wells, the guide protector comprising:
a shielding portion for covering at least some of said columns and rows;
a dispensing window for selectively exposing a targeted one of said columns or rows to allow for dispensing into the targeted column or row, and
said guide protector being at least transversely or axially movable relative to the multi-well plate to selectively align said window with said targeted column or row.

2. The multi-well plate guide protector of claim 1, further comprising a positioning mechanism for guiding the movement of the guide protector relative to the plate such that the protector can move in a series of incremental positions, each position aligning said dispensing window to a column or row of the plate.

3. The multi-well plate guide protector of claim 2, wherein said positioning mechanism comprises parallel, spaced apart sidewalls extending generally perpendicularly from opposite sides of said shielding portion; the sidewalls being adapted to axially or transversely engage corresponding peripheral walls of a housing that locates the multi-well plate.

4. The multi-well plate guide protector of claim 3, further comprising positioning lugs extending from the sidewalls and engageable with corresponding alignment recesses in the multi-well plate holder, the recesses having distances apart matching the distance between the columns or row for accurate positioning of the window with the columns or rows.

5. The multi-well plate guide protector of claim 1 further comprising a door for covering said dispensing window, said door being movable relative to said shielding portion to incrementally uncover said window in increments of one well for single well dispensing.

6. The multi-well plate guide protector of claim 5, wherein the door is slidable relative to the shielding portion to expose said window.

7. The multi-well plate of claim 5, further comprising a track in the shielding portion for guiding the door.

8. The multi-well plate guide protector of claim 1, further comprising indicia adjacent the dispensing window to aid in locating the window with a selected one of said columns or rows.

9. A multi-well plate guide protector set for multi-well dispensing in a multi-well plate comprising axially extending columns and transversely extending rows of wells, the guide protector set comprising:
a base for mounting a multi-well plate;
a guide protector at least axially or transversely movably mounted to the base, said guide protector including:
a shielding portion for covering at least some of said columns and rows;
a dispensing window for selectively exposing a targeted one of said columns or rows by transversely or axially sliding the guide protector relative to the base until the window aligns with the targeted column or row to allow for dispensing into the targeted column or row.

10. The multi-well plate guide protector set of claim 9 further comprising a housing for locating the multi-well plate.

11. The multi-well plate guide protector set of claim 9 further comprising a positioning mechanism for guiding the movement of the guide protector relative to the plate such that the protector can move in a series of incremental positions, each position aligning said dispensing window to a column or row of the plate.

12. The multi-well plate guide protector of claim 11, wherein the guide protector further comprises parallel, spaced apart sidewalls extending generally perpendicularly from opposite sides of said shielding portion, the sidewalls further adapted to axially or transversely engage corresponding peripheral walls of a housing that locates the multi-well plate.

13. The multi-well plate guide protector of claim 12, further comprising positioning lugs extending from the sidewalls and engageable with corresponding alignment recesses in the base, the recesses having distances matching the distance of the column or row for aligning the window with the columns or rows.

14. The multi-well plate guide protector of claim 9 further comprising a door for covering said dispensing window, said door being movable relative to said shielding portion to incrementally uncover said window in increments of one well for single well dispensing.

15. The multi-well plate guide protector of claim 14, wherein the door is slidable relative to the shielding portion to expose said window.

16. The multi-well plate of claim 15, further comprising a track in the shielding portion for guiding the door.

17. The multi-well plate guide protector of claim 9, further comprising indicia adjacent the dispensing window to aid in locating the window with a selected one of said columns or rows.

18. The multi-well plate guide protector set of claim 9, wherein said base holds two multi-well plates.

19. A method of performing dispensing in a multi-well plate, the method comprising the steps of:
(i) selecting in a sequential order the wells for dispensing;
(ii) covering the rest of the wells that are not for dispensing and exposing the target wells selected for dispensing;
(iii)dispensing fluid into the exposed target wells;
(iv)covering the target wells where dispensing has been completed and exposing the next target wells for dispensing; and
(v) repeating steps (iii) and (iv) until all the target wells have been dispensed in a sequential order.

20. The method of claim 19, wherein said covering step is performed using a multi-well plate guide protector according to claim 1 by moving said guide protector relative to the multi-well plate to align said dispensing window with a target row or column of said multi-well plate; and step (iv) is performed by moving said guide protector relative to the multi-well plate to align said dispensing window with the next target row or column of said multi-well plate.

21. A method of performing single-row, single-column, or single-well dispensing in a multi-well plate, the method comprising the steps of:
a. providing a multi-well plate guide protector set according to claim 9,
b. moving said guide protector to align said dispensing window with a target row or column;
c. dispensing fluid into said target row or column; and
d. transferring fluid from a target well in a source plate to a target well in the daughter plate.

22. A method according to claim 21, wherein steps (b) and (c) are repeated until a required number of said wells are filled.

23. A method of transferring fluid between a source multi-well plate and a daughter multi-well plate, the method comprising the steps of:
a. providing a multi-well plate guide protector set according to claim 9, said guide protector set having a said guide protector for said source multi-well plate and a said guide protector for said daughter multi-well plate;
b. moving the guide protector for the source plate to align its dispensing window with a target row or column in said source plate and moving the guide protector for the daughter plate to align its dispensing window with a target row or column in said daughter plate; and
c. transferring fluid from a target well in the source plate to a target well in the daughter plate; and
d. repeating seps (b) and (c) until a required number of wells in said daughter plate is filled.

24. The method according to claim 23 wherein said multi-well plate is a 12-, 24- 96- or 384-well plate.

25. The multi-well plate guide protectors according to claim 1 wherein said multi-well plate is a 12-, 24- 96- or 384-well plate.
